(19) United States
(12) Patent Application Publication
(10) Pub. No.: US 2011/0003234 A1
(43) Pub. Date: Jan. 6, 2011

(54) Polymer Composition, Polymer Membrane Comprising the Polymer Composition, Process for Preparing it and Fuel Cell Comprising the Membrane

(75) Inventors: Roland Martin, St-Stevens-Woluwe (BE); Jean-Pierre Catinat, Waudrez (BE); Jean-Raphael Caille, Namur (BE); Veronique Van Pee, Vilvoorde (BE)

Correspondence Address: Solvay;c/o B. Ortego - IAM-NAFTA, 3333 Richmond Avenue, Houston, TX, 77098-3099, US

(73) Assignee: SOLVAY (SOCIETE ANONYME), Brussels (BE)

(21) Appl. No.: 12/919,072

(22) PCT Filed: Feb. 26, 2009
(86) PCT No.: PCT/EP2009/052250

§ 371 Date: Aug. 24, 2010

(30) Foreign Application Priority Data
Feb. 27, 2008 (EP) 08151975.3

(51) Int. Cl. H01M 8/10; C08K 3/32; B05D 5/12

(52) U.S. Cl. 429/492; 524/417; 427/115

(57) ABSTRACT

A polymer composition comprising (a) a polybenzimidazole derived from (a1) at least one bis-(ortho-diamino) aromatic compound and (a2) at least one aromatic carboxylic acid or derivative thereof, each containing at least two acid groups and at least one hydroxyl group in α-position of a carboxylic group; (b) orthophosphoric acid; and (c) polyphosphoric acids of the formula (I): HO[P(O)(OH)]ₙH, wherein n is an integer from 2 to 20, wherein the polyphosphoric acids of formula (I) are present in an amount of less than 2 mol %, based upon the sum of moles of orthophosphoric acid (b) and polyphosphoric acids (c), and wherein (b) is present in an amount of 1 to 75 moles per mol of a benzimidazole group formed from (a1) and (a2). A polymer membrane comprising the polymer composition, a preferred process for preparing the membrane, and a fuel cell comprising the membrane.

The present invention relates to a polymer composition which is suitable for solid polymer electrolyte membranes, a polymer membrane comprising the polymer composition, a preferred process for preparing the membrane, and a fuel cell comprising the membrane.

Fuel cells are practical and versatile power sources, which can be more efficient and less environmentally damaging than other power sources. The application potential for fuel cells is thus growing rapidly. Fuel cells convert energy that is stored in chemical form into electricity. In contrast to batteries, they oxidize externally supplied fuel and do not have to be recharged.

Fuel cells can be configured in numerous ways with a variety of electrolytes, fuels and operating temperatures. For example, fuels such as hydrogen or methanol can be provided directly to the fuel cell electrode or fuels such as methane or methanol can be converted to a hydrogen rich gas mixture external to the cell itself (fuel reforming) and subsequently provided to the fuel cell. The source of oxygen in most fuel cells is air and in some cases hydrogen peroxide or a cryogenic storage system.

Although there are theoretically a limitless number of combinations of electrolyte, fuel, oxidant, temperatures and so on, practical systems are in many cases based on proton exchange membrane fuel cell (PEMFC) technology, which employs a solid polymer electrolyte system using hydrogen or methanol as fuel source and oxygen or air as oxidant. A PEMFC has the advantage that it can be miniaturized as compared with other types of fuel cells and is thus suitable as mobile power source or as small capacity power source.

The polymer electrolyte membrane in the PEMFC acts as a proton-exchange membrane. It must have excellent ion conductivity, physical strength, gas barrier properties, chemical stability, electrochemical stability and thermal stability under the operating conditions of the fuel cell. Membranes commonly used in PEMFC are made from perfluorinated sulfonic acid (PFSA) polymers such as NAFION resins from DuPont. These membranes have demonstrated good performance, long-term stability in both oxidative and reductive environments and significant proton conductivity under fully hydrated conditions (80-100% relative humidity (RH)) at low temperature (up to 80° C.) and require a sophisticated water management (system complexity). Moreover, on account of the methanol crossover, these membranes are unsuitable for a DMFC (direct methanol fuel cell).

Great efforts have been undertaken to develop proton exchange membranes for operation at temperatures above 100° C. Proton-conducting, i.e. acid-doped, polyazole membranes allow the use in fuel cells at operating temperatures above 100° C. These membranes for use in PEM fuel cells are in general doped with concentrated phosphoric acid or sulfuric acid and then act as proton conductors and separators in polymer electrolyte membrane fuel cells. The activity of the catalysts based on noble metals present in the membrane-electrode unit and the tolerance of significantly higher concentrations of CO impurities during the long-term operation of a fuel cell might thus be increased.

Proton-conducting polymer membranes based on polyazoles which are particularly suitable for use as polymer electrolyte membrane (PEM) for producing membrane-electrode units for PEM fuel cells are described for example in EP 1739115 A1, WO 2005/063862 A1, WO 2004/055097 A1, WO 2005/063852 A1 and in the article “High-Temperature Polybenzimidazole Fuel Cell Membranes via a Sol-Gel Process” by L. Xia, H. Zhang, E. Scanlon, L. s. Ramanathan, Eui-Won Choe, D. Rogers, T. Apple and B. C. Benicewicz” in Chem. Mater. 2005, Vol. 17, pages 5328-5333.

The most promising approach is a polybenzimidazole (PBI)/H₃PO₄ acid doped membrane, which does not require external humidification, possesses high proton conductivity (at temperatures above 150° C.), with little effect of product water, has a near zero electro-osmotic water drag and an at least ten times lower methanol permeability as compared to NAFION® resins.

US 2004/0096734 A1 discloses a proton-conducting polymer membrane based on polyazoles which is obtainable by a process comprising the steps
A) mixing of one or more aromatic tetramino compounds with one or more aromatic carboxylic acid or esters thereof which contain at least two acid groups per carboxylic acid monomer, or mixing one or more aromatic and/or heteroaromatic diaminocarboxylic acids, in polyphosphoric acid to form a solution and/or dispersion,
B) application of a layer to a support using the mixture from step A),
C) heating of the flat structure/layer obtainable as described in step B) to temperatures of up to 350° C., preferably up to 280° C., under inert gas to form the polyazole polymer,
D) treating the membrane formed in step C) until it is self-supporting.

US 2004/0096734 A1 discloses among several aromatic tetramino compounds the use of 3,3′,4,4′-tetraminobiphenyl, 2,3,5,6-tetraminopyridine and 1,2,4,5-tetraminobenzene and among several aromatic dicarboxylic acids isophthalic acid, terephthalic acid, 5 hydroxyisophthalic acid, 4-hydroxyisophthalic acid, 2-hydroxyterephthalic acid, and 2,5-dihydroxyterepthalic acid.

However, known PBI/H₃PO₄ doped membranes suffer from major drawbacks. For the use in a fuel cell, the membrane should have sufficient good mechanical properties. Preferably, the membranes should be at least self-supporting. This is especially a problem in doped membranes, since the acid used as dopant, for example orthophosphoric acid, acts as plasticizer. Because of the high acid doping levels required to attain sufficient conductivity, their mechanical strength is limited due to the plasticizing effect of the dopant. Also, the phosphoric acid content decreases over time, particularly during start-up and shut-down when it is washed by liquid product water. As a result of these conflicting requirements for membranes in fuel cells, a sufficient balance of conductivity and mechanical properties has so far not been achieved.

Fibers made from polyareneazoles having pendant OH-groups are known from WO 06/105232 A1. As an example, the polybenzimidazole from the monomers 1,2,4,5-tetramino benzene (DAB) and 2,5-dihydroxyterephthalic acid (DHTA) monomers is disclosed.

It is thus an object of the present invention to provide a polymer composition comprising a polybenzimidazole which can be used for the manufacture of a polymer membrane that is useful in fuel cells and which has an improved balance between mechanical and conductivity properties.

The present invention is thus directed to a polymer composition comprising

(a) a polybenzimidazole derived from
(a1) at least one bis-(ortho-diamino) aromatic compound and
(a2) at least one aromatic carboxylic acid or derivative thereof, each containing at least two acid groups and at least one hydroxyl group in α-position of a carboxylic group;
   (b) orthophosphoric acid; and
   (c) polyphosphoric acids of the formula (I)

HO[P(O)(OH)]ₙH (I),

wherein n is an integer from 2 to 20,

wherein the polyphosphoric acids of formula (I) are present in an amount of less than 2 mol %, based upon the sum of moles of orthophosphoric acid (b) and polyphosphoric acids (c), and wherein (b) is present in an amount of 1 to 75 moles per mol of a benzimidazole group formed from (a1) and (a2).

The polybenzimidazole in the polymer composition of the present invention is thus derived from (a1) at least one bis-(ortho-diamino) aromatic compound and (a2) at least one aromatic carboxylic acid or derivative thereof, each containing at least two acid groups and at least one hydroxyl group in α-position of a carboxylic group.

For the purposes of the invention, the meaning of the term “bis-(ortho-diamino) aromatic compound (a1)” comprises the bis-(ortho-diamino) aromatic compound as such and its salts with acids such as hydrochloric acid, sulfuric acid and phosphoric acid.

The bis-(ortho-diamino) aromatic compound (compound (a1)) which may be used in accordance with the present invention is not specifically limited. Preferred examples for the bis-(ortho-diamino) aromatic compound (compound (a1)) are however 1,1′-biphenyl-3,3′,4,4′-tetraamine (DAB), 1,2,4,5-tetraminobenzene, 3,3′,4,4′-tetraminodiphenyl ether, 3,3′,4,4′-tetraminodiphenyl thioether, 3,3′,4,4′-tetraminodiphenylsulfone, 2,2-bis(3,4-diaminophenyl)propane, bis(3,4-diaminophenyl)methane, 2,2-bis(3,4-diaminophenyl)hexafluoropropane, 2,2-bis(3,4-diaminophenyl)ketone, bis(3,4-diaminophenoxy)benzene and derivatives thereof, such as salts with acids such as hydrochloric acid, sulfuric acid and phosphoric acid.

The at least one aromatic acid or derivative thereof, each containing at least two acid groups and at least one hydroxyl group in α-position of a carboxylic group (compound (a2)) is not particularly restricted. The derivative can be for example a salt, ester, or acid halide form of the acid.

Preferred examples for compound (a2) are 5-hydroxyisophthalic acid; 4-hydroxyisophthalic acid; 2-hydroxyterephthalic acid; 2,5-dihydroxyterepthalic acid; 2,6-dihydroxyterepthalic acid; 2,6-dihydroxyisophthalic acid; 4,6-dihydroxyisopthalic acid; 2,3-dihydroxyphthalic acid; 2,4-dihydroxyphthalic acid; 3,4-dihydroxyphthalic acid; and 1,8-dihydroxynaphthalene-3,6-dicarboxylic acid.

Compound (a2) may also be a heteroaromatic compound. Examples thereof are pyridine-3-hydroxy-2,5-dicarboxylic acid; pyridine-3-hydroxy-2,5-dicarboxylic acid; pyridine-3,6-dihydroxy-2,5-dicarboxylic acid; pyridine-3-hydroxy-2,4-dicarboxylic acid; and pyridine-3,6-dihydroxy-2,4-dicarboxylic acid.

A particularly preferred compound (a1) is 3,3′,4,4′-tetraminobiphenyl (DAB) and a particular preferred compound (a2) is 2,5-dihydroxyterephthalic acid (DHTA). In the composition of the present invention, both 3,3′,4,4′-tetraminobiphenyl and 2,5-dihydroxyterephthalic acid are used in combination.

In addition to the compounds (a1) and (a2), the polybenzimidazole derived from compounds (a1) and (a2) may be derived also from other monomers (all) and (a22), respectively.

Compounds (a11) which might be used as co-monomers in addition to compounds (a1) contain preferably at least one azole forming group. For the purpose of the invention, the term “azole-forming group” denotes a group able to react with another suitable azole-forming group to form an azole ring, i.e. an imidazole, thiazole or oxazole ring. Examples of “azole-forming groups” include ortho-diamine groups (formula 1), ortho-aminohydroxy groups (formula 2), and ortho-aminothiol groups (formula 3).

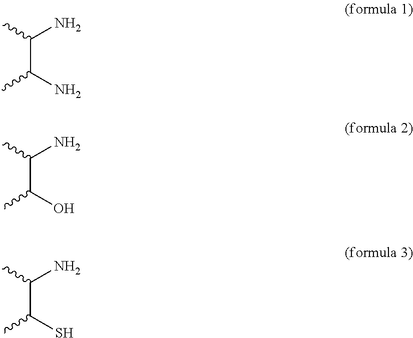

Suitable non-limiting examples of other monomers (a22) are aromatic dicarboxylic acids or derivatives thereof without OH group. Specific examples are aromatic dicarboxylic acids such as terephthalic acid, 1,3-benzenedicarboxylic acid, 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene and derivatives thereof such as alkaline metal salts of sodium, potassium, ammonium and the like.

The compounds (a22) may comprise a sulfone group. Specific examples of dicarboxylic acid monomers comprising at least one sulfonic acid group are 2,5-dicarboxybenzenesulfonic acid, 3,5-dicarboxybenzenesulfonic acid, 2,5-dicarboxy-1,4-benzenedisulfonic acid, 4,6-dicarboxy-1,3-benzene-disulfonic acid, 4,4′-dicarboxy-3,3′-(biphenylsulfone) disulfonic acid, as well as and derivatives thereof such as alkaline metal salts of sodium, potassium, ammonium and the like.

The polybenzimidazole (a) of the present invention may also comprise diamino-carboxylic acid monomers (a22). The term “diamino-carboxylic acid monomer” denotes herein an aromatic compound comprising at least one carboxylic acid group as such or its salt, ester, or acid halide, and at least one ortho-diamine group as such and/or its salt with an acid such as hydrochloric acid, sulfuric acid and phosphoric acid.

Compounds (a1) and compounds (a11), as well as compounds (a2) and compounds (a22) may be arranged in order or statistically. Accordingly, the polybenzimidazole (a) in the composition of the present invention can be a homopolymer, or a statistical or block copolymer.

The polymer composition of the present invention comprises (b) orthophosphoric acid and (c) polyphosphoric acids of the formula (I)

HO[P(O)(OH)]ₙH (I),

wherein n is an integer from 2 to 20,
wherein the polyphosphoric acids of formula (I) are present in an amount of less than 2 mol %, based upon the sum of moles of orthophosphoric acid (b) and polyphosphoric acids (c), and wherein (b) is present in an amount of 1 to 75 moles per mol of a benzimidazole group formed from (a1) and (a2).

Orthophosphoric acid (b) is preferably present in an amount of 2 to 10 moles per mol of the benzimidazole group and more preferably in an amount of 2 to 6 moles per mol of the benzimidazole group.

The content of the polybenzimidazole (a) in the polymer composition of the present invention can vary to a large extent. Preferably, the polybenzimidazole (a) is contained in an amount of from 1 to 75 weight %, based upon the total weight of the polymer composition.

In this regard it is to be noted that the composition may comprise, depending upon the optional use and amount of compounds (a11) and (a22) as co-monomers, polybenzimidazoles with recurring units based upon benzothiazole and benzoxazole. Accordingly, the term “polybenzimidazole” as used herein denotes polymers comprising at least 50 mol % recurring units based upon benzimidazole as such and up to 50 mol % recurring units based upon benzothiazole and/or benzoxazole.

The recurring units may be sulfonated. In general, the amount of sulfonated recurring units is less than 50 mol %, preferably less than 40 mol %, more preferably less than 30% and most preferably less than 20 mol %, based upon the total number of moles of recurring units.

The polybenzimidazole polymer of the invention has preferably an intrinsic viscosity of at least 0.5 dl/g, preferably at least 0.6 dl/g, more preferably at least 0.8 dl/g, when measured in H₂SO₄ 97% at 30° C.

The polybenzimidazole polymer is advantageously soluble in polar aprotic solvents like NMP, DMSO, DMF, DMA and advantageously soluble in strong acids like for example methansulfonic acid, triflic acid, chlorosulfonic acid, sulfuric acid, and polyphosphoric acid (PPA).

The polymer composition may also comprise water. Preferably, the polymer composition further comprises less than 40 weight % water, based upon the total weight of the polymer composition.

In addition to polybenzimidazole, water, phosphoric acid and polyphosphoric acid, the polymer composition of the invention may comprise additional components like for example other polymers and low molecular components to improve mechanical and other properties of the polymer composition for an intended use.

The polymer composition of the invention can be advantageously used in a polymer membrane, in particular in a polymer membrane for fuel cells. In this regard, the polymer composition of the present invention can easily give free standing polymer membranes.

Accordingly, in a second aspect, the present invention is directed to a polymer membrane comprising the polymer composition as described above.

It has been found that the polymer membrane of the present invention is especially advantageous, showing significantly improved mechanical properties, when the polymer membrane shows a first WAXD (wide angle X-ray diffraction) peak with a maximum in the range of 2Θ from 12° to 21° and a second WAXD peak with a maximum in the range of 2Θ from 23° to 30°.

In this embodiment, it is preferred that the first WAXD peak maximum is in the range of 2Θ from 14° to 18°, in particular in the range of 2Θ from 15° to 17°, and the second WAXD peak maximum is in the range of 2Θ from 23° to 28°, in particular in the range of 2Θ from 25° to 27°.

Most preferably, the intensity of the first WAXD peak maximum is greater than the intensity of the second WAXD peak maximum. It is especially advantageous, when a ratio between the intensity of the first WAXD peak maximum and the intensity of the second WAXD peak maximum is greater than 1.5, or even more advantageous, if it is greater than 2.0.

The polymer composition of the present invention and the polymer membrane of the present invention are in general obtained by polymerization of the compounds (monomers) (a1) and (a2), possibly in combination with additional monomers (a11) and (a22). The polymerization can be carried out by polymerizing the corresponding monomers directly to the desired final benzimidazole. Alternatively, the corresponding monomers may be first reacted to prepolymers which are reacted to the desired final benzimidazole in a subsequent step.

The reaction between the monomers is advantageously carried out in a mineral acid, preferably in polyphosphoric acid (PPA) at a temperature between 100 and 240° C. PPA generally acts as solvent, catalyst and dehydrating agent. The term PPA is intended to denote a mixture of condensed phosphoric acid oligomers of general formula:

Hₙ₊₂PₙO₃ₙ₊₁

wherein the average value of n depends on the ratio of water to phosphorus pentoxide (P₂O₅).

The composition of PPA will be described hereinafter by the P₂O₅ weight content, expressed as percent of the weight of the P₂O₅ divided by the total weight of PPA. The concentration of PPA is advantageously from 80 to 86 wt % P₂O₅, preferably from 82 to 85 wt % P₂O₅.

The chemical reaction between the monomers will depend upon their chemical nature. A carboxylic acid group advantageously reacts with a group chosen among ortho-diamine, ortho-hydroxyamine and ortho-aminethiol group to yield an imidazole, oxazole or thiazole ring, respectively.

In carrying out the polymerization process, shall the tetraamine monomers or diamino carboxylic acid monomer(s) be available as hydrochloric acid salts, substantially stoichiometric amounts of compounds (a1) and (a2) and possibly further monomer(s) (a11) and (a22) are preferably first heated at 40-80° C. in PPA (50 to 80 wt % P₂O₅) to advantageously effect dehydrochlorination. This step is advantageously carried out under reduced pressure to facilitate removal of generated hydrogen chloride. After complete dehydrochlorination, or after mixing the monomer(s) in PPA, in case tetraamine monomers and/or diamino carboxylic acid monomer(s) are available as such, an additional quantity of P₂O₅ and/or PPA may be added as required to provide a stirrable mixture and to increase the concentration of PPA within the range of 80-86% wt P₂O₅.

During the polycondensation reaction, additional amounts of P₂O₅ may be added for maintaining the concentration of PPA advantageously between 80-86 wt %, preferably between 82-84 wt % P₂O₅.

It is preferred to carry out the polymerization in stages, i.e. a step-wise heating schedule is employed. Such a schedule is preferred because immediately exposing the reaction mixture to relatively high polymerization temperature may cause decomposition of one or more monomers. The selection of a particular step-wise heating schedule is obvious to one of ordinary skill in the art. While an optimum polymerization temperature is not unconditionally definable, because this optimum depends on the combination of monomers, temperature exceeds, at least in one step of the polymerization, advantageously 100° C., preferably 120° C., and more preferably 140° C. An exemplary heating schedule is for instance 60° C. for 4 hours, 100° C. for 2 hours, 160° C. for 24 hours and 190° C. for 4 hours.

Equimolar amounts of compounds (a1) and (a2) generally enable preparation of a (pre)polymer which is terminated on one side with a carboxylic acid group and on the other side with an ortho-diamine group. A slight excess of compound (a2) (typically less than 10% mol, preferably less than 5% mol) with respect to stoichiometric amounts, generally enables the preparation of a (pre)polymer which is terminated with carboxylic acid groups, and a slight excess of compound (a1) (typically less than 10% mol, preferably less than 5% mol) generally enables the preparation of a (pre)polymer that is terminated with an ortho-diamine group.

Upon the termination of the polymerization reaction, in general after cooling the reaction mixture, the polybenzimidazole polymer can be recovered by precipitation in water. However, the preferred process is direct casting of the polyphosphoric acid (PPA) polymerization medium.

A particularly preferred process of manufacturing the polymer composition of the present invention, in particular in the form of a polymer membrane, comprises the steps
A) polymerizing in polyphosphoric acid a mixture of (a1) at least one bis-(ortho-diamino) aromatic compound and (a2) at least one aromatic carboxylic acid or derivative thereof, each containing at least two carboxylic groups and at least one hydroxyl group in α-position of a carboxylic group to form a solution and/or dispersion of a polybenzimidazole;
B) applying the solution and/or dispersion from step A) as a layer (b1) with a thickness of from 50 to 5000 μm to a support (b2);
C) hydrolyzing the polyphosphoric acid of layer (b1) with water or a water containing liquid or gaseous atmosphere to form a free-standing membrane (b3) containing low molecular weight polyphosphoric acid and/or orthophosphoric acid; and
D) executing on the membrane (b3) obtained in step C) one or several dehydration-rehydration cycles and removing drained-off phosphoric acid to reduce the amount of (b) orthophosphoric acid and (c) polyphosphoric acids to the desired amount, so as to obtain a membrane (b4).

This process may be characterized as “direct casting” of a membrane which may be removed from its support once it is free-standing.

In step B), the solution and/or dispersion of step A) is preferably applied onto the support (b2) at a temperature above 140° C. and more preferably above 165° C. but below the decomposition temperature of the polymer. In that case, layer (b1) is preferably cooled to a temperature below 100° C. during step C).

In a preferred embodiment of this process, dehydration(s) of step D) is effected by heating membrane (b3) at a temperature of from 50 to 350° C. for 0.5 to 24 hours, preferably 100 to 300° C. for 0.5 to 24 h, or by using a dessicant.

The use of a dessicant is not particularly restricted. Suitable dessicants are CaCl₂, P₄O₁₀, and activated alumina. Doping levels with orthophosphoric acid can be adjusted for example by multiple cycles consisting of drying the membrane over P₂O₅ in a dessicator at room temperature and rehydration at ambient air, and wiping off the drained-off liquid and drying.

It has been found however that the effect of using dehydration-rehydration cycles where dehydration is carried out at higher temperature, i.e. above room temperature, gives rise to membranes with better mechanical properties at the same doping level.

Preferably, rehydration(s) of step D) is effected by contacting membrane b3) with a water containing liquid or gaseous atmosphere. This can be done for example by leaving the polymer composition or membrane as obtained under ambient conditions of temperature, pressure and humidity. The higher the humidity, the faster the rehydration will proceed in general.

In the embodiment of the present invention comprising step D), membrane (b3) is preferably cooled to a temperature below 100° C. before rehydration.

After step D), the doping level of membrane (b4) is below the doping level of membrane (b3).

Preferably, rehydration is effected in a gaseous atmosphere with a humidity content (RH) of at least 10% by weight.

In the process of the invention, rehydration is performed preferably at low temperatures and dehydration at high temperatures.

It has been found that particularly preferred polymer membranes are obtained when during step D), the polymer composition is cycled between a temperature in the range of from 20 to 40° C. at RH of from 10 to 100% and a temperature in the range of from 100 to 350 at RH of from 0 to 5%.

In another preferred embodiment of the present invention, the process of the invention further comprises the step
E) thermally treating membrane (b4) by heating at a temperature of from 150 to 350° C. for 1 to 24 hours, so as to obtain a membrane (b5).

In this embodiment, step E) is preferably effected by heating membrane (b4) at a temperature of from 200 to 300° C. for 1 to 15 hours. This embodiment is especially preferred when step D) has been conducted at a temperature below 200° C., and even more preferably: when it has been conducted at a temperature below 250° C.

In the embodiment of the present invention comprising step E), membrane (b4) is preferably cooled to a temperature below 100° C. before applying said step and then heated to a temperature of from 200 to 300° C., most preferably, from 230 to 270° C. during said step.

It has been found that heating at least once the membranes at a temperature of at least 200° C., preferably at least 250° C. for at least 1 hour, during a step D) and/or during a step E), gives rise to membranes (b4 or b5) with better mechanical properties.

Preferably, step D) and/or step E) are performed under air or under an inert gas atmosphere so that they result in a structural change without any crosslinking by interaction with oxygen.

In the process of the present invention, the use of the monomer (a1) and (a2) is not particularly restricted. It is however very much preferred that (a1) is 3,3′,4,4′-tetraminobiphenyl and that (a2) is 2,5-dihydroxyterephthalic acid.

It has turned out that the polymer membrane as discussed herein, in particular when obtained with the above cited monomers and in accordance with the process described herein implying a step (D) or E)) of heating the membrane at a temperature of at least 200° C. (preferably at least 250° C.), is particularly useful as polymer electrolyte membrane in a fuel cell.

Such a membrane has namely for a given doping level (DL), a higher tensile strength (TS) than other membranes used in this application. To be more precise: membranes with a product TS (in MPa) by DL (in mol/mol) or TS·DL of at least 100, even at least 120 and even at least 150 can be obtained. This is especially the case with membranes having a DL between 4 and 14, even more between 2 and 12 (mol/mol).

Accordingly, the present invention is also directed to the use of the polymer membrane as described in this specification (and more preferably: as described in the § above) as a polymer electrolyte membrane in a fuel cell, as well as to a fuel cell, comprising this membrane.

The fuel cell comprising the membrane of the present invention is preferably a hydrogen or methanol fuel cell. Due to the polybenzimidazole polymer as above described, it is possible to maximize ion conductivity without decreasing the mechanical properties of the membrane. There is furthermore no unacceptable degree of swelling or even complete dissolution in water or in methanol. The thermal resistance of the solid polymer electrolyte membrane and thus of the fuel cell is high. Accordingly, the fuel cell may be operated under a high operating temperature.

The invention will be described in the following by means of Examples which are illustrative only and not intended to limit the present invention as claimed in the appended claims.

### EXAMPLES

### PA-Doped Polybenzimidazole Membranes Made from DAB and DHTA Monomers

3.479 g of 2,5-hydroxyterephthalic acid (17.6 mmol), 3.763 g of 3,3′,4,4′-tetraminobiphenyl (17.6 mmol) and 262.4 g of pre-degassed polyphosphoric acid (P2O5 content 83.3 wt %) have been introduced under inert atmosphere into a 250 ml three necked round-bottom flask. This mixture maintained under inert atmosphere has been successively heated under stirring at 100° C. for 1 h, at 150° C. for 3.5 h and finally at 165° C. for 18 h leading to a transparent brownish green medium (polymer concentration: 2.2 wt %).

Polymer films have been prepared by casting directly the hot polymerization solution (T°: 165° C.) onto glass plates, in air, using an ELCOMETER 4344/11 motorised applicator and ELCOMETER 3545 adjustable Bird film applicators (250-1000 μm). The glass plates and Bird applicator have been preheated at 100° C. before use.

After casting, the polybenzimidazole films were left to cool to room temperature and hydrolyze on their support at room temperature and ambient air (relative humidity RH: 55%) for a period of time of 24 h to 1 week. Upon standing, moisture was absorbed from the surrounding atmosphere and the polyphosphoric acid (PPA) was hydrolyzed into orthophosphoric acid (PA). PA and water exuded out of the polybenzimidazole film and were wiped away.

The direct casting of the polymerization mixtures led right from the end of the PPA hydrolysis process to true membranes which could be lifted from their substrates with tweezers and wiped without any damage (even for more diluted solutions, e.g. PBI with approximately 1 wt %), contrary to what has been observed in the case of 3,3′,4,4′-tetraminobiphenyl and isophthalic acid monomers. Membranes made from DHTA and DAB remained transparent throughout the hydrolysis process, appearing fluorescent yellow just after casting and orange to orange brown when hydrolyzed.

The doping level (DL) with orthophosphoric acid of the so obtained membranes has been adjusted by successive cycles consisting in thermal dehydration treatments under air at 100 or/and 250° C. followed by rehydration at room temperature and ambient air (relative humidity RH: 55%, duration: 1 day to 1 week) and wiping of the resulting drained-off liquid. Dehydration treatments at 100° C. have been performed using a HERAEUS UT 20 P ventilated oven, while those at 250° C. have been performed using a THERMOLYNE 30400 muffle furnace.

A thermal treatment at 205° C. has also been performed in some cases using a THERMOLYNE 30400 muffle furnace.

This thermal treatment at 250° C. has been performed under nitrogen in one example, the results of which are shown in FIGS. 1 and 2. Essentially no difference was observed on the membrane mechanical properties.

In some examples, the PA-doping level has also been adjusted by multiple cycles consisting in drying the membrane on P2O5 in a dessicator at room temperature+rehydration at ambient air+wiping of the drained-off liquid.

### Comparative Examples

### PA-Doped Polybenzimidazole Membranes Made from DAB and IA Monomers

The Examples were repeated except that isophthalic acid was used instead of 2,6-dihydroxy-terephthalic acid as compound (a2).

7.572 g of isophthalic acid (45.6 mmol), 9.766 g of 3,3′,4,4′-tetraminobiphenyl (45.6 mmol) and 628.9 g of pre-degassed polyphosphoric acid (P2O5 content 83.3 wt %) have been introduced under inert atmosphere into a 500 ml three necked round-bottom flask. This mixture maintained under inert atmosphere has been successively heated under stirring at 100° C. for 1 h, at 150° C. for 1 h, at 180° C. for 18 h and finally at 200° C. for 24 to 70 h (polymer concentration: 2.2 wt %).

Casting, PPA hydrolysis step and PA-doping level adjustment has been performed using the same procedures as for Examples 1.

Contrary to membranes made from DHTA and DAB monomers, the polybenzimidazole films from IA and DAB obtained after casting, PPA hydrolysis and liquid PA drain-off phase showed a very low integrity after step C and broke up when handled with tweezers.

The experimental conditions of the examples and the comparative examples are detailed in Table 1 enclosed to the present specification. In this table, a “x” means that no such step has been performed.

Some properties of the membranes obtained in the (comparative) examples (doping level, tensile strength, conductivity and wide-angle X-Ray diffraction) are shown in FIGS. 1 to 4. They were obtained as follows:

### Membrane Composition (and Doping Level DL)

Determination of membrane composition is essential for the understanding of conductivity measurement results. For the different samples, the content in H3PO4 and polybenzimidazole was thus determined by the following method using cut-out pieces of the respective membrane. At first, the membrane was dried at 135° C. during 30 minutes in order to determine the water content. Then, H3PO4 was extracted from the membrane by water at reflux temperature and then by treatment with a basic solution of NaOH. Finally the polybenzimidazole polymer was rinsed with water and dried at 135° C. until its weight remained constant. By these two simple manipulations one could evaluate water and H3PO4 contents while polymer content was deduced from these results.

### Conductivity

The conductivity measurements have been carried out using four probes impedance spectroscopy. An alternative current was applied to the membranes through two platinum electrodes and the voltage is measured between two others. Voltage is measured for different frequencies while impedance is defined as the ratio of potential/current at a given frequency. When impedance is independent of frequency, i.e. when membrane resistance is separated from the interfacial resistance between membrane and electrode, the resistance of the membrane is the value of impedance for a phase angle equal to zero degree.

A Bekktech conductivity cell was used that was connected to a Hydrogenics station in order to control the environmental conditions (temperature, RH, gas flow) of the membranes during the conductivity measurements. The membrane has been connected to a Wayne Kerr 6440B Impedance Analyzer through 4 coaxial cables. After determination of the resistance, conductivity is obtained with the relation:

σ(S/cm)=l(cm)/R(Ω)×L(cm)×e(cm)

with:
R=resistance measured
l=distance between electrodes where voltage is measured
L=membrane width
e=membrane thickness

### Mechanical Properties

The mechanical properties of the membranes obtained in the Examples 1 and Comparative Examples have been tested by tensile measurements.

Tensile measurements were run under atmospheric conditions at 23° C. with a test speed of 1 mm/min onto dumbbell specimen.

### Wide Angle X-Ray Diffraction

Wide-angle X-ray Diffraction analyses were performed on a Philips diffractometer (PW1729 generator, PW2233/20 tube, PW1050 Bragg-Brentano goniometer, graphite monochromator, PW1711/10 Xenon proportional detector, PW1710 control unit), with CuKα X-ray radiation (λ=0.154 nm).

### DESCRIPTION OF THE FIGURES

FIG. 1 shows a relation between tensile strength (TS, in MPa and measured at 23° C.) and doping level (DL, mol/mol) for membranes according to the invention comprising a polybenzimidazole from 3,3′,4,4′-tetraminobiphenyl and 2,5-dihydroxyterephthalic acid, and comparative membranes comprising a polybenzimidazole from 3,3′,4,4′-tetraminobiphenyl and isophthalic acid.

FIG. 2 shows for membranes according to the invention comprising a polybenzimidazole from 3,3′,4,4′-tetraminobiphenyl and 2,5-dihydroxyterephthalic acid the effect of the thermal treatment temperature on the tensile strength for different doping levels.

FIG. 3 shows a relation between conductivity and tensile strength for membranes according to the invention comprising a polybenzimidazole from 3,3′,4,4′-tetraminobiphenyl and 2,5-dihydroxyterephthalic acid, and comparative membranes comprising a polybenzimidazole from 3,3′,4,4′-tetraminobiphenyl and isophthalic acid.

FIG. 4 shows for different membranes WAXD (wide angle X-ray diffraction) diagrams where intensity (INT, in arbitrary units) is plotted vs. 2Θ. In these figures, curves 1 to 6 do not relate to trials 1 to 6 of table 1 but to other ones, the conditions of which are detailed in the legend thereof. In these trials, the duration of steps D was 0.5 hour and the duration of steps E was 5 hours.

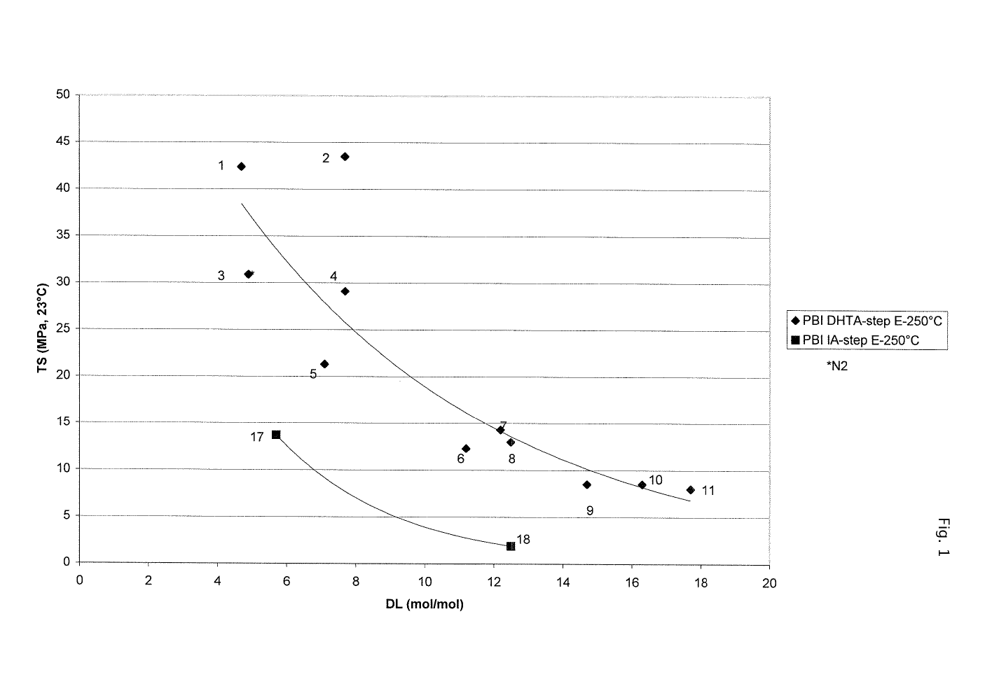

A comparison of the results of the Examples and Comparative Examples in FIG. 1 clearly shows that, at the same PA-doping level, the mechanical properties are better for a polymer membrane according to the present invention where the polymer composition comprises a polybenzimidazole from 3,3′,4,4′-tetraminobiphenyl and 2,5-dihydroxyterephthalic acid (DHTA) as compared to the polymer membrane of the Comparative Example where the polymer composition comprises a polybenzimidazole from 3,3′,4,4′-tetraminobiphenyl and isophthalic acid (IA). With DHTA, the product TS·DL goes from 120 to 300 while with IA, it only goes from about 25 to about 80.

Polybenzimidazole derived from isophthalic acid is a reference in the field of proton conducting membranes doped with phosphoric acid. Accordingly, the observation that the membrane of the present invention reveals a better compromise between conductivity and mechanical properties demonstrates the advantages of the present invention. This advantage is especially pronounced for doping levels equal to or below 14 and even more for doping levels equal to or below 12.

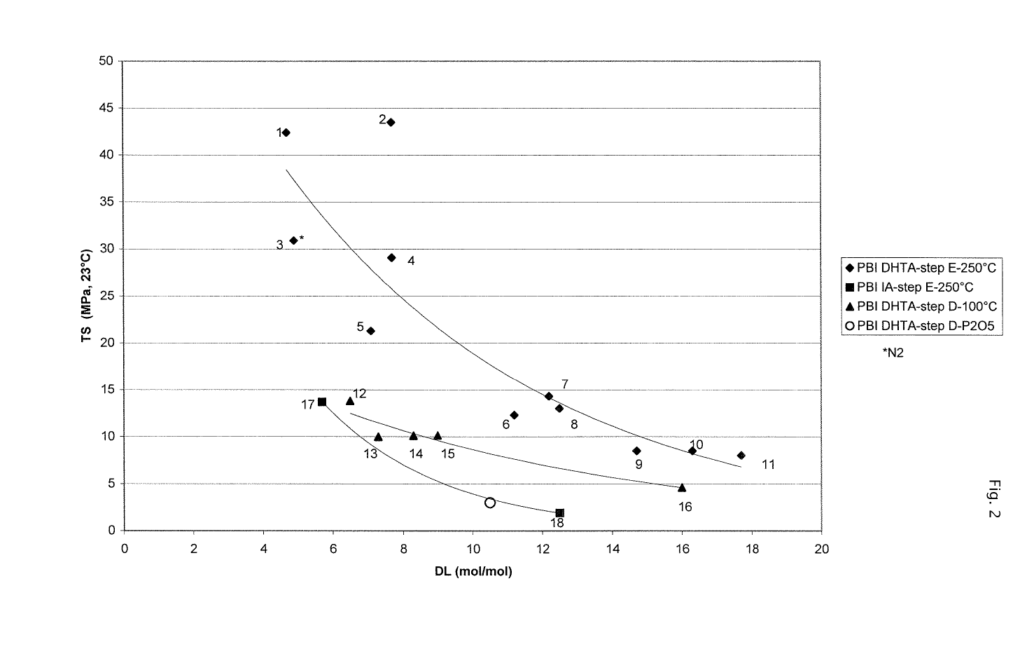

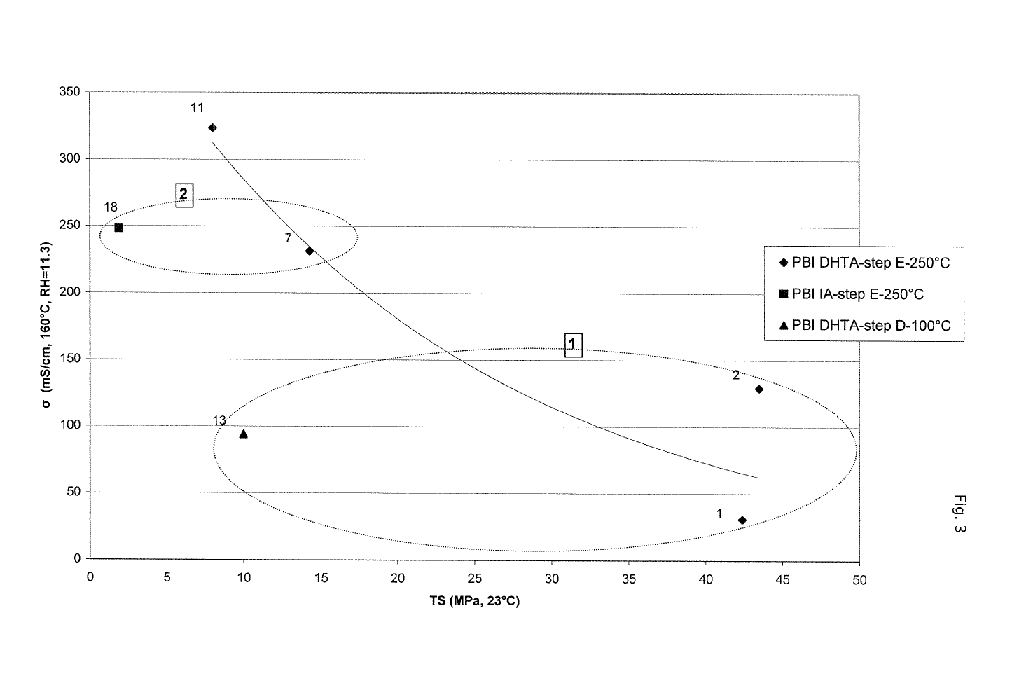

As is apparent from FIG. 2 and FIG. 3, thermal treatments at 250° C. greatly improve the mechanical properties of the polymer membranes of the present invention as compared, at the same doping level, to a thermal treatment performed at 100° C. Ellipse 1 in FIG. 3 illustrates that for similar conductivity level (and hence: doping level), mechanical properties of membranes heated at temperature of 250° C. are higher than those of membranes only treated at 100° C.

The experimental results in FIG. 3 revealed that polymer membranes of the present invention show an improved balance between mechanical and conductivity properties as compared to membranes made from a polybenzimidazole derived from 3,3′,4,4′-tetraminobiphenyl and isophthalic acid. Ellipse 2 suggests that for a similar conductivity level, mechanical properties of PBI DHTA based membranes are better than those of PBI IA based membranes.

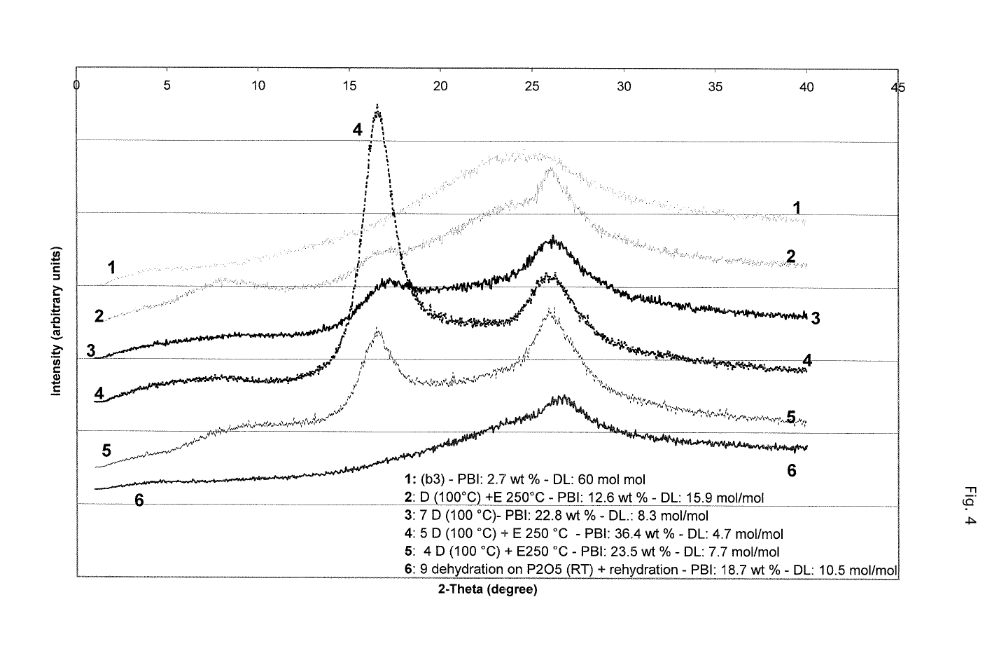

Doped PBI membranes according to the invention which were characterized by a very low PBI content (≈3.0 wt %) and high doping level (>50 mol/mol) did not show any distinct diffraction peaks. Only a very large peak centered at 2θ≈24.5° could be observed. The situation was different for membranes involving at least one thermal treatment preferably at 250° C. As PBI content increased due to consecutive treatments (steps D and E), crystallinity increased and diffraction peaks appeared more and more clearly at 2 Θ≈26° (d≈0.34 nm) and 16.5° (d≈0.54 nm). The peak at 2Θ≈26° was the first to emerge, but when the PBI content reached 12 to 15 wt %, a second peak at 2Θ≈16.5° begun to appear and became the most prominent peaks for PBI contents and doping levels resp. near to 25 wt % and 6-8 mol/mol. It appeared in fact as a very sharp, highly intense peak in an Example with a PBI content and doping level resp. equal to 36.4 wt % and 4.7 mol/mol (FIG. 4).

The membranes which showed the best mechanical properties were those for which the most intense and sharp peak at 2Θ≈16.5° was observed.

Membranes with step D dehydrations performed only at 100° C. showed, at the same PBI content and doping level, lower crystallinity than those thermally treated one time at 250° C. after several dehydration-rehydration cycles with dehydration at 100° C. For the same doping level, those treated only at 100° C. presented also worse mechanical properties than those treated at least one time at 250° C. (FIG. 2).

Despite its rather high PBI content (18.7 wt %), the membrane example submitted to multiple drying on P₂O₅-rehydration-wiping cycles led to an X-ray diffraction pattern showing poor crystallinity as compared to those cured at 250° C. showing lower PBI content (12.6 and 16.1 wt %). This membrane showed also poor mechanical properties (FIG. 2). Higher PBI content as such was thus not sufficient to achieve high crystallinity and good mechanical properties.

Moreover, FIG. 4 shows that the improvement in mechanical properties for a polymer membrane made of a polybenzimidazole from 3,3′,4,4′-tetraminobiphenyl and 2,5-dihydroxyterephthalic acid is somewhat tied to a structural change as evidenced by a peak at 2Θ=16.5°. This can namely be seen by comparing the results on samples 3 and 5 which have a similar doping level (DL) but in which the peak at 16.5° indicates a more pronounced structural change for sample 5, which was submitted to a heating step at 250° C., than for sample 3, which was not.

TABLE 1
Experimental conditions

| | step D | | | | step E | |
|---|---|---|---|---|---|---|
| | 100° C. | | 250° C. | | 250° C. | |
| | | time/ | | time/ | | time/ |
| PBI DHTA-step E- | | cycle | | cycle | | cycle |
| 250° C. | cycles | (h) | cycles | (h) | cycles | (h) |
| 1 | 5 | 0.5 | x | x | 1 | 5 |
| 2 | 2 | 0.5 | 2 | 1.5 | 1 | 1.5 |
| 3 | 4 | 0.5 | 1 | 0.7 | 1 | 5 |
| 4 | 4 | 0.5 | x | x | 1 | 5 |
| 5 | 3 | 0.5 | x | x | 1 | 5 |
| 6 | 2 | 0.5 | x | x | 1 | 5 |
| 7 | 2 | 0.5 | x | x | 1 | 5 |
| 8 | 2 | 0.5 | x | x | 1 | 5 |
| 9 | 2 | 0.5 | x | x | 1 | 5 |
| 10 | 2 | 0.5 | x | x | 1 | 5 |
| 11 | 1 | 0.5 | x | x | 1 | 5 |

| | |
|---|---|
| | step D |
| PBI DHTA-step D- | 100° C. |

| 100° C. | cycles | time/cycle (h) |
|---|---|---|
| 12 | 6 | 0.5 |
| 13 | 7 | 0.5 |
| 14 | 7 | 0.5 |
| 15 | 4 | 0.5 |
| 16 | 2 | 0.5 |

| | step D | | | | step E | |
|---|---|---|---|---|---|---|
| | 100° C. | | 250° C. | | 250° C. | |
| | | time/ | | time/ | | time/ |
| | | cycle | | cycle | | cycle |
| PBI IA-step E-250° C. | cycles | (h) | cycles | (h) | cycles | (h) |
| 17 | 3 | 0.5 | x | x | 1 | 5 |
| 18 | x | x | x | x | 1 | 5 |

1. A polymer composition comprising
(a) a polybenzimidazole derived from
(a1) at least one bis-(ortho-diamino) aromatic compound and
(a2) at least one aromatic carboxylic acid or derivative thereof, each containing at least two acid groups and at least one hydroxyl group in α-position of a carboxylic group;
(b) orthophosphoric acid; and
(c) polyphosphoric acids of the formula (I)
HO[P(O)(OH)]ₙH (I),
wherein n is an integer from 2 to 20,
wherein the polyphosphoric acids of formula (I) are present in an amount of less than 2 mol %, based upon the sum of moles of orthophosphoric acid (b) and polyphosphoric acids (c), and wherein (b) is present in an amount of 1 to 75 moles per mol of a benzimidazole group formed from (a1) and (a2).

2. The polymer composition according to claim 1, wherein (a1) is 3,3′,4,4′-tetraminobiphenyl and wherein (a2) is 2,5-dihydroxyterephthalic acid.

3. The polymer composition according to claim 1, wherein (b) is present in an amount of 2 to 10 moles per mol of the benzimidazole group.

4. (canceled)

5. The polymer composition according to claim 1, wherein the polybenzimidazole (a) is contained in an amount of from 1 to 75 weight %, based upon the total weight of the polymer composition.

6. The polymer composition according to claim 1, further comprising less than 40 weight % water, based upon the total weight of the polymer composition.

7. A polymer membrane comprising the polymer composition according to claim 1.

8. A polymer membrane comprising the polymer composition according to claim 2 and having a tensile strength TS (in MPa) and a doping level DL (in mol/mol) such that TS·DL is at least equal to 100.

9. The polymer membrane according to claim 8, having a DL between 4 and 14 (mol/mol).

10. The polymer membrane according to claim 7, showing a first WAXD (wide angle X-ray diffraction) peak with a maximum in the range of 2Θ from 12° to 21° and a second WAXD peak with a maximum in the range of 2Θ from 23° to 30°.

11. The polymer membrane according to claim 10, wherein the first WAXD peak maximum is in the range of 2Θ from 14° to 18° and the second WAXD peak maximum is in the range of 2Θ from 23° to 28°.

12. The polymer membrane according to claim 10, wherein the intensity of the first WAXD peak maximum is greater than the intensity of the second WAXD peak maximum.

13. The polymer membrane according to claim 12, wherein a ratio between the intensity of the first WAXD peak maximum and the intensity of the second WAXD peak maximum is greater than 1.5.

14. The polymer membrane according to claim 13, wherein the ratio between the intensity of the first WAXD peak maximum and the intensity of the second WAXD peak maximum is greater than 2.0.

15. A process for obtaining the polymer membrane of claim 7, comprising the steps
A) polymerizing in polyphosphoric acid a mixture of (a1) at least one bis-(ortho-diamino) aromatic compound and (a2) at least one aromatic carboxylic acid or derivative thereof, each containing at least two carboxylic groups and at least one hydroxyl group in α-position of a carboxylic group to form a solution and/or dispersion of a polybenzimidazole;
B) applying the solution and/or dispersion from step A) as a layer (b1) with a thickness of from 50 to 5000 μm to a support (b2);
C) hydrolyzing the polyphosphoric acid of the layer (b1) with water or a water containing liquid or gaseous atmosphere to form a free-standing membrane (b3) containing low molecular weight polyphosphoric acid and/or orthophosphoric acid; and
D) executing on the membrane (b3) obtained in step C) one or several dehydration-rehydration cycles and removing drained-off phosphoric acid to reduce the amount of (b) orthophosphoric acid and (c) polyphosphoric acids to the desired amount, so as to obtain a membrane (b4).

16. The process according to claim 15, wherein in step B), the solution and/or dispersion of step A) is applied onto the support (b2) at a temperature above 140° C. but below the decomposition temperature of the polymer and wherein the layer (b 1) is cooled to a temperature below 100° C. during step C).

17. The process according to claim 15, wherein the dehydration(s) of step D) is effected by heating the membrane (b3) at a temperature of from 50 to 350° C. for 0.5 to 24 hours or by using a dessicant.

18. The process according to claim 15, wherein one or more rehydrations of step D) is or are effected by contacting the membrane (b3) with a water containing liquid or a gaseous atmosphere.

19. The process according to claim 18, wherein one or more rehydrations is or are effected in a gaseous atmosphere with a humidity content of at least 10% by weight.

20. The process according to claim 19, wherein during step D), the polymer composition is cycled between a temperature in the range of from 20 to 40° C. at relative humidity (RH) of from 10 to 100% and a temperature in the range of from 100 to 350° C. at RH of from 0 to 5%.

21. The process according to claim 15, further comprising a step E) of thermally treating the membrane (b4) by heating at a temperature of from 150 to 350° C. for 1 to 24 hours, so as to obtain a membrane (b5).

22. The process according to claim 21, wherein the membrane (b4) is cooled to a temperature below 100° C. before applying step E) and then heated to a temperature of from 200 to 300° C. during said step E).

23. The process according to claim 21, wherein the membrane (b4) or (b5) is heated at least once at a temperature of at least 200° C. during said step D) and/or during said step E).

24. The process according to claim 15, wherein (a1) is 3,3′,4,4′-tetraminobiphenyl and wherein (a2) is 2,5-dihydroxyterephthalic acid.

25. A method of use of the polymer membrane of claim 15 as a polymer electrolyte membrane in a fuel cell.

26. A fuel cell comprising the membrane of claim 7.
